(19) United States
(12) Patent Application Publication
(10) Pub. No.: US 2015/0298493 A1
(43) Pub. Date: Oct. 22, 2015

(54) METHOD FOR DECORATING WOOD SURFACES

(71) Applicant: Leif Erling HOPE, Sag Harbor, NY (US)

(72) Inventor: Leif Erling HOPE, Sag Harbor, NY (US)

(21) Appl. No.: 14/689,888

(22) Filed: Apr. 17, 2015

Related U.S. Application Data
(60) Provisional application No. 61/980,862, filed on Apr. 17, 2014.

(51) Int. Cl. B44C 1/00

(52) U.S. Cl. CPC B44C 1/005

(57) ABSTRACT

A method for generating a novel, decorative and finished visual effect on a surface of common engineered wood-based products is provided. The method may include smoothing the surface; establishing a multifaceted refractory quality; sealing the established multifaceted refractory quality; prepping the surface for adhesion of a plurality of visual material; adhering at least one visual material along a portion of the surface; complementarily coloring the at least one visual material; and uniformly protecting the generated visual effect on the surface.

### CROSS-REFERENCE TO RELATED APPLICATION

This application claims the benefit of priority of U.S. provisional application number 61/980,862, filed 17 Apr. 2014, the contents of which are herein incorporated by reference.

### BACKGROUND OF THE INVENTION

The present invention relates to woodworking and, more particularly, to a method for generating a novel, decorative and finished visual effect on a surface of common engineered wood-based products.

No other material surface captures and reflects light as strikingly as varnished natural wood grain. And since wood also provides structural strength, it is the material of choice by engineers, architects and designers worldwide for a variety of uses. Besides being expensive for certain sizes and shapes, natural wood has inherent dimensional limits in terms to length and width, and so engineers, architects and designers turn to engineered wood-based products in their designs. Such engineered wood-based products include, but are not limited to, sheet/panel boards and structural members formed from composites and/or laminates of wood flakes, wafers or strands; a common example would be plywood. Such engineered wood-based products provide a rough, choppy surface that, though retaining a portion of an underlying wood grain, is far less visually appealing than varnished natural wood.

Three major approaches have been used up until now to enhance the visual dynamism of the surfaces of the engineered wood-based products. Historically, decorative treatments of such surfaces have relied heavily on the underlying wood-based product supplemented by stains and dyes, but as mentioned above, these are constricted to the limited color palette of available species. Then synthetic laminates assumed a large role in the last century, with the flowering of printing technologies opening a vast color and pattern library. These are superficial solutions however, and are visually flat (since they are printed on the surface), structurally vulnerable and stylistically random. More recently, 3-D CNC patterns and textures are machined into panels to generate interest, but these may compromise the structural integrity of the underlying wood product, and typically are difficult to join, clean and use as a working surface, such as for tabletops or countertops.

As can be seen, there is a need for a method for generating a novel, decorative and finished visual effect on a surface of common engineered wood-based products, yet retaining the underlying wood product's structural integrity, while providing a usable work surface which may be flat, easy to join, and clean.

### SUMMARY OF THE INVENTION

In one aspect of the present invention, a method for generating color and/or visual variability on a substrate of a predetermined base wood material includes sealing a stained portion of the substrate; and adhering at least one visual material along an unexposed portion of the substrate, wherein the remaining exposed portion is substantially shared by the stained portion.

In another aspect of the present invention, a method for generating color and/or visual variability on a substrate of a predetermined base wood material includes smoothing the substrate along a stained portion of the substrate; establishing a multifaceted refractory quality substantially along the stained portion of the substrate; sealing substantially the stained portion of the substrate with a sealing agent, wherein the sealing agent is resistant to a supplemental coloring agent, and wherein the sealing agent is thin-bodied to prevent substantially filling a rough, differentiated surface of the substrate; prepping generally a non-stained portion of the substrate for adhesion of at least one visual material; adhering the at least one visual material along an unexposed portion of the substrate, wherein the remaining exposed portion is substantially shared by the stained portion; sanding down the at least one visual material; coloring the at least one visual material with the supplemental coloring agent; and uniformly protecting the substrate

In yet another aspect of the present invention, a wood-based material product having a generated visually dynamic surface includes a substrate having a rough, differentiated surface; a stained portion of the substrate; a first coloring agent defining the stained portion; at least one visual material adhered to an unexposed portion of the substrate, wherein the remaining exposed portion is substantially shared by the stained portion; and a supplemental coloring agent received by the least one visual material.

These and other features, aspects and advantages of the present invention will become better understood with reference to the following drawings, description and claims.

### BRIEF DESCRIPTION OF THE DRAWINGS

FIG. 1 is a section perspective view of an exemplary embodiment of the present invention;

FIG. 2 is a section perspective view of an exemplary embodiment of the present invention;

FIG. 3 is a section perspective view of an exemplary embodiment of the present invention; and

FIG. 4 is a section perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for generating a novel, decorative and finished visual effect on a surface of common engineered wood-based products. The method may include smoothing the surface; establishing a multifaceted refractory quality; sealing the established multifaceted refractory quality; prepping the surface for adhesion of a plurality of visual material; adhering at least one visual material along a portion of the surface; complementarily coloring the at least one visual material; and uniformly protecting the generated visual effect on the surface.

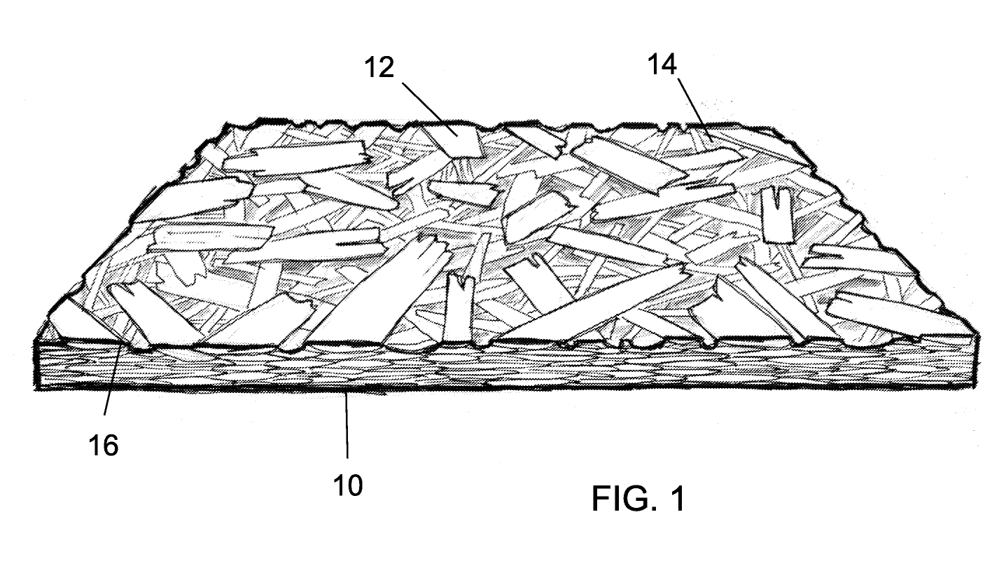

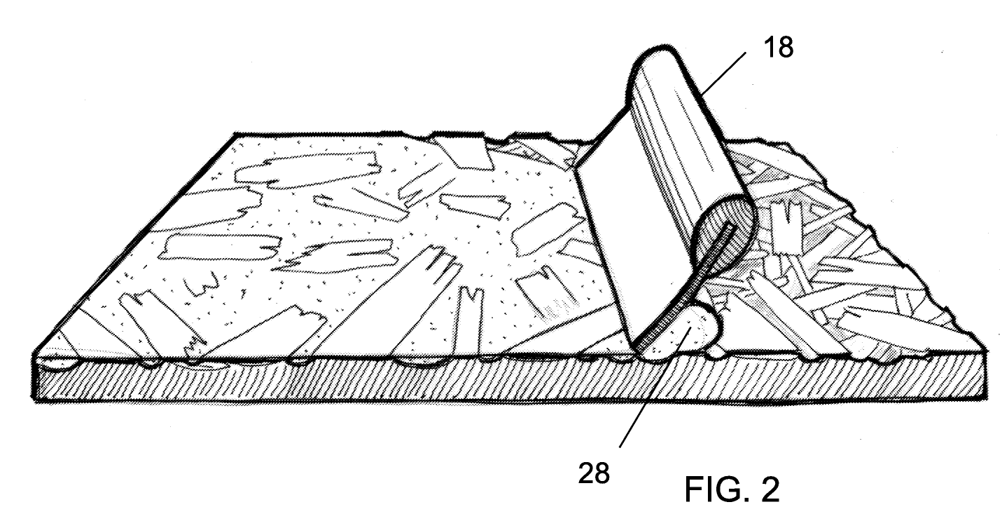

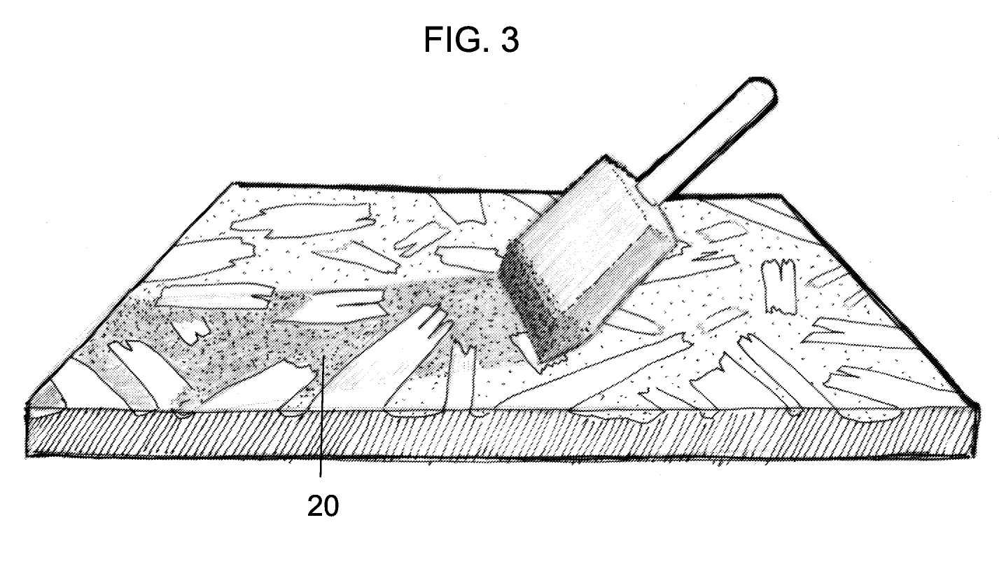

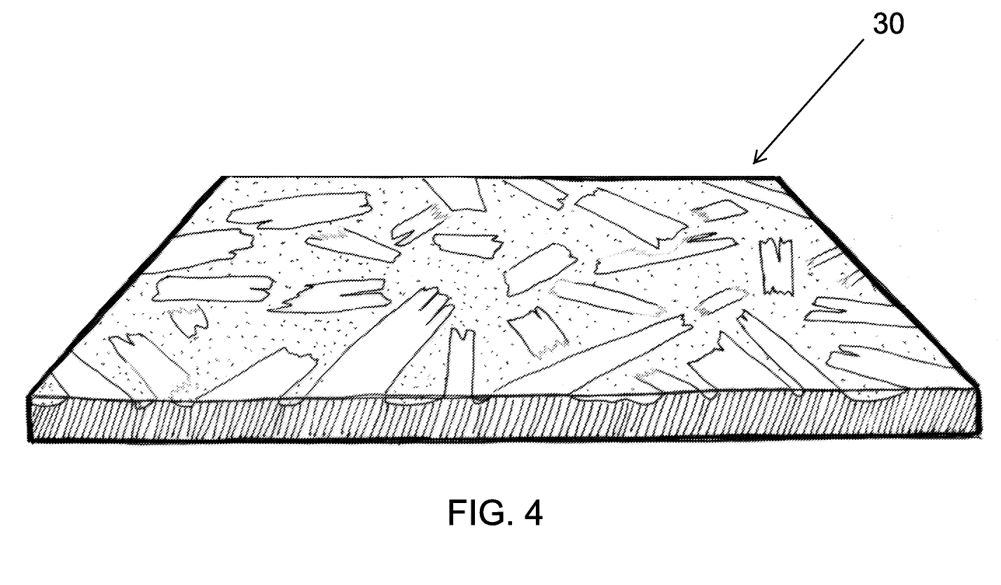

As illustrated in FIGS. 1 through 4, the present invention may embody a method for generating a novel, decorative and finished visual effect 30 on a surface of common engineered wood-based products. The method may include selecting a predetermined wood-based material 10 enabling a rough, differentiated surface 16 for decorating. The wood-based material 10 may be dimensioned and adapted to form the structurally and/or architecturally required engineered product and/or provide a suitable rough, differentiated surface 16 on which the desired visual effect 30 may be represented. In certain embodiments, the wood-based material may include the pre-formed engineered wood-based product. Typically, such engineered wood-based product may be formed from the composite and/or laminate of wood flakes, wafers, strands or other wood-based elements 14 into panel/sheet boards, veneers or dimensioned (structural) members. For example, such engineered wood-based product may include those products commonly known as Waferboard, Oriented Strand Board (OSB), Oriented Strand Lumber (OSL), Parallel Strand Lumber (PSL), Laminated Strand Board (LSB), Laminated Strand Lumber (LSL), several types of Engineered I-Joist products and the like. Such engineered wood-based product may provide a rough surface having recessed, differentiated surface, typically between the varying composite wood-based elements that formed the engineered wood-based product. Yet at the same time, the rough surface retains at least one wood grain of the wood-based elements. Moreover, the rough surface typically provides a visually interesting, variegated pattern. In one embodiment of the present invention, the rough, differentiated surface 16 having integrated wood grains 12 and a variegated pattern, may be leveraged to generate the novel, decorative and finished visual effect 30.

After selecting the predetermined wood-based material 10 or the engineering wood-based product forming the suitable rough, differentiated surface or substrate 16, the method may include smoothing or fairing the rough surface/substrate, in step 1, establishing a surface which may substantially finish smoothly and flat. The smooth portion of the substrate engaged by a sanding mechanism may be adapted to ultimately convey the richness of the natural wood component, integrated wood grains 12, and/or wood-based elements 14. In certain embodiments, remaining portions of the substrate 16 may be missed by the sanding because they are recessed. Said remaining recessed portions may accept at least one visual material in subsequent steps.

In step 2, the method may include establishing a multifaceted refractory quality by applying a first coloring agent to at least a portion of the surface/substrate of the wood-base material/product. The first coloring agent may include stains, dyes, varnish, shellac, lacquer, and the like. The first coloring agent may be received on a stained portion of the substrate so as to establish the multifaceted refractory qualities unique to the integrated wood grain 12 so as to reflect light differently from different angles, in contrast to other materials which reflect light monotonously. In an alternative embodiment, chemical fuming may be used to tint the wood-based material 10 instead of the first coloring agent.

In step 3, the method may include sealing the established multifaceted refractory quality by applying a sealing agent to at least a portion of the stained portion of the substrate. The sealing agent may be adapted be a thin-bodied liquid so as to not completely fill the rough, differentiated surface, and the recesses, pocks and like that may be formed thereon, thereby leaving the rough, differentiated surface for subsequent steps. The sealing agent may be also be adapted to isolate, resist and/or prevent subsequent reactivation, bleeding into and/or dilution of the first coloring agent, subsequent coats, covers, tints, or otherwise obscuring the effects of the first coloring agent. The sealing agent may include various sealing and varnishing materials. The application of the sealing agent may include a plurality of coats of the sealing agent.

In step 4, the method may include prepping of portions of the substrate 16 for adhesion of at least one visual material 28, as the surface may now have raised grain caused by the stain or the sealer. Said prepping may be accomplished by sanding or similar means whereby, any grain which may have been raised in previous steps is eliminated, and ensuring proper adhesion of subsequent coats and/or visual material; for example, by gently scuffing/sanding the prepped portion down with a finer grade sanding material. Step 4 may address any grain-raising or other imperfections which may have been caused by the staining and sealing.

In step 5, the method may include adhering at least one visual material 28 along the prepped portion of the substrate. The at least one visual material may be adapted to substantially to completely fill the recessed, pocked portions of the rough, differentiated surface 16 and provide a receptacle for a supplemental coloring agent 20. The at least one visual material 28 may include spackle, epoxy and other compositions having adhesive properties. The at least one visual material 28 may be opaque and somewhat porous to absorb the supplemental color. The at least one visual material 28 may be applied so as to generally level the plane of the substrate/surface by filling the remaining recesses, pocks and depressions of the rough, differentiation surface/substrate 16. In certain embodiments, the at least one visual material 28 may not be adhered to all of the smooth portions of the substrate, leaving an exposed portion of the substrate. Such adhesion can be done with an edged applicator 18, such as a spackle knife, a rubber-type squeegee, or the like. This can be fully automated or applied by hand.

In step 6, the method may include further sanding to enhance and complete the flattening of portions of the substrate. Sanding may be used to establish the plane for the finished exposed integrated wood grain 12 portion of the pattern. The family of panel or structural members which are the engineered wood-based product typically used for this process, and described in further detail below, may usually be considered an element of rough or frame construction, and requires a little care to get it to finish smoothly.

In step 7, the method may include applying a supplemental coloring agent 20. The supplemental coloring agent 20 may include stains, dyes, varnish, shellac, lacquer, and the like. The supplemental color itself may be adapted to more or less complement or more or less contrast the stained portion of the substrate, and so highlighting visual dynamism and interest of the surface of wood-based material. In alternative embodiments, supplemental color can be incorporated into the at least one visual material 28 prior to its adherence to the substrate, obviating the need for step 7. Note that the exposed portion of the substrate may be sealed pursuant step 3 by the sealing agent so as to resist the supplemental color agent 20, whereby after being washed, the first and the supplemental coloring is portioned to the exposed and the non-exposed portions, respectively.

In step 8, the method may include uniformly protecting the generated visual effect by applying a top sealing agent and a top coating. The top sealing agent and/or top coating may be adapted to unify and protect the generated desired visual effect; for example, by providing a uniform sheen over the variegated colors and texture of the generated desired visual effect along the wood-base material 10 surface.

It should be understood that sufficient time may be required to lapse between each step to enable sufficient drying, cleaning and the like, necessary for the subsequent step.

A method of using the present invention may include a user selecting a primary color which may be the color of the first coloring agent and thus the color of the exposed portion of the substrate. The rough, differentiated substrate 16 may then be smoothed, forming the smooth portion and the recessed portion. Then the user may adhere at least one visual material to at least the recessed portion, forming the non-exposed portion of the substrate, wherein the at least one visual material 28 may be adapted to receive a supplemental color of the supplemental color agent 20.

In certain embodiments, there is no first coloring agent applied to the substrate, if the color of the unstained wood is the desired color for the exposed portion, obviating step 2. In certain embodiments, the sealing agent may be omitted if bleeding of colors is desired.

The at least one visual material may be applied before the first coloring agent, as the visual material 28 may accept the first color agent differently from the wood. This could then be stained/dyed so that the visual material creates a new color in combination with the base color underneath, or the visual material 28 may be adapted to resist the top stain/dye because it is non-porous.

The materials and finishes resulting from this method may allow design professionals to specify, from a wide range of finishes, patterns which are predictable, visually dynamic and optically rich, and may be integral with the material rather than adhered to the surface. These materials may be available in a much wider range of dimensions than anything else currently available. The materials may be orientation-neutral, so that designers, fabricators and installers do not need to consider grain direction. These materials are dimensionally more stable than other available materials.

An architect, designer, furniture-maker, builder, fabricator or the like, may use the final material to design and construct elements in the built environment that are not subject to the random contingencies of what wood-grain pattern may be available, yet do not ask the client to make concessions on the ability to clean. It satisfies enduring modern aesthetic demands that surface treatments not be superficial applications of foreign materials, but reflects the nature of the material.

In certain embodiments, the system may be used to produce cabinets, furniture, wall paneling, flooring, countertops, columns, beams, braces, jewelry boxes; anywhere a decorative surface may be desired, whether superficial or structural.

It should be understood, of course, that the foregoing relates to exemplary embodiments of the invention and that modifications may be made without departing from the spirit and scope of the invention as set forth in the following claims.

What is claimed is:

1. A method for generating color and/or visual variability on a substrate of a predetermined base wood material, comprising:
sealing at least a stained portion of the substrate; and
adhering at least one visual material along an unexposed portion of the substrate, wherein the remaining exposed portion is substantially shared by the stained portion.

2. The method of claim 1, further comprising coloring at least the at least one visual material with a supplemental coloring agent.

3. The method of claim 2, wherein the at least one visual material is colored with the supplemental coloring agent prior to being adhered along the unexposed portion.

4. The method of claim 1, further comprising establishing a multifaceted refractory quality generally along the stained portion of the substrate prior to sealing it.

5. The method of claim 4, wherein at least one application of a first coloring agent establishes the multifaceted refractory quality.

6. The method of claim 4, further comprising smoothing generally along the stained portion of the substrate prior to the establishing a multifaceted refractory quality.

7. The method of claim 1, further comprising prepping generally the unexposed portion of the substrate prior to the adhesion of the at least one visual material.

8. The method of claim 2, further comprising sanding down the at least one visual material prior to coloring with the supplemental coloring agent.

9. The method of claim 2, further comprising uniformly protecting the substrate as a final step.

10. The method of claim 1, wherein the sealing agent is thin-bodied to prevent substantially filling a rough, differentiated surface of the substrate.

11. The method of claim 1, wherein the sealing agent is resistant to the supplemental coloring agent.

12. A method for generating color and/or visual variability on a substrate of a predetermined base wood material, comprising:
smoothing a rough, differentiated surface of the substrate along a stained portion of the substrate;
establishing a multifaceted refractory quality substantially along the stained portion of the substrate;
sealing substantially the stained portion of the substrate with a sealing agent, wherein the sealing agent is resistant to a supplemental coloring agent, and wherein the sealing agent is thin-bodied to prevent substantially filling a rough, differentiated surface of the substrate;
prepping generally a non-stained portion of the substrate for adhesion of at least one visual material;
adhering the at least one visual material along an unexposed portion of the substrate, wherein the remaining exposed portion is substantially shared by the stained portion;
sanding down the at least one visual material;
coloring the at least one visual material with the supplemental coloring agent; and
uniformly protecting the substrate.

13. A wood-based material product having a generated visually dynamic surface, comprising:
a substrate having a rough, differentiated surface;
a stained portion of the substrate;
a first coloring agent defining the stained portion;
at least one visual material adhered to an unexposed portion of the substrate, wherein the remaining exposed portion is substantially shared by the stained portion; and
a supplemental coloring agent received by the least one visual material.
